(19) United States
(12) Patent Application Publication
(10) Pub. No.: US 2011/0049830 A1
(43) Pub. Date: Mar. 3, 2011

(54) Cycle propelling mechanism

(76) Inventor: Ta Chun Hung, Hsinchu (TW)

(21) Appl. No.: 12/584,363

(22) Filed: Sep. 3, 2009

(51) Int. Cl. B62M 1/04

(52) U.S. Cl. 280/256

(57) ABSTRACT

A cycle propelling mechanism includes a rail disposed on a cycle frame, two cranks rotatably coupled to the cycle frame with a main drive shaft, two levers each include one end pivotally coupled to the crank and the other end slidably coupled to the rail for allowing the levers to be moved cyclically relative to the cycle frame, and two foot pedals pivotally attached to the levers for being stepped and operated by user's feet and for allowing the cranks and the lever to be rotated relative to the cycle frame in an elliptical moving stroke and for allowing the foot pedals to be stepped and moved for a longer stepping or moving stroke by the user, and for effectively exercising the more or bigger muscle groups of the user, and for applying bigger power to the cycle propelling mechanism.

### BACKGROUND OF THE INVENTION

1. Field of the Invention

The present invention relates to a cycle propelling mechanism, and more particularly to a cycle propelling mechanism including a simplified structure for allowing the cycles to be easily and effectively operated or driven or propelled by the user and for effectively exercising the more or bigger muscle groups of the user, and for applying bigger power to the cycle propelling mechanism.

2. Description of the Prior Art

Typical cycle propelling mechanisms comprise a pair of foot pedals rotatably coupled to a main drive shaft or a cycle device, such as a unicycle, bicycle, tricycle or the like with cranks for allowing the main drive shaft and the wheels of the cycle device to be rotated or driven by the foot pedals.

However, the foot pedals are rotated or driven cyclically by the user, and only about one quarter of the cyclically moving stroke of the foot pedals may be effectively operated or driven or propelled by the user such that the user may not effectively operate or drive or propel the foot pedals.

The other typical cycle devices may comprise different driving or propelling devices for operating or driving or propelling the foot pedals.

For example, U.S. Pat. No. 594,980 to Booth & Scott discloses one of the typical cycle propelling mechanisms comprising two pedal levers pivotally coupled to the cycle frame and slidably engaged with the cranks that are coupled to the main drive shaft.

However, the foot pedals and the pedal levers may only be stepped up and down by the user, and the user may not effectively exercise his muscle groups. In addition, the pedal levers have an increased horizontal stroke which is perpendicular to the active force and which is useless and which may not do work and which includes a decreased efficiency, such that the typical cycle propelling mechanisms may not be merchandized.

U.S. Pat. No. 4,077,648 to Seul discloses another typical bicycle propulsion and speed change means comprising two pedal levers pivotally coupled to the cycle frame and coupled to the rear wheel axle with a complicated coupling mechanism.

However, the complicated coupling mechanism may not be easily manufactured and assembled and may greatly increase the manufacturing cost for the typical bicycle propulsion and speed change means. In addition, the stepping operation to the foot pedals may not be continuously operated such that the wheels may not be rotated in a great speed, and the muscle groups of the rider may easily fatigue.

U.S. Pat. No. 4,666,173 to Graham discloses a further typical foot pedal drive for bicycles and comprising two elongated pedal bars pivotally coupled to the cycle frame and coupled to the rear wheel axle with a complicated coupling mechanism.

However, the complicated coupling mechanism may not be easily manufactured and assembled and may greatly increase the manufacturing cost and processes for the typical foot pedal drives for the bicycles. In addition, the stepping operation to the foot pedals may not be continuously operated such that the wheels may not be rotated in a great speed, and the muscle groups of the rider may easily fatigue.

U.S. Pat. No. 4,872,695 to Silvano et al. discloses a still further typical kinematic device for bicycles and comprising two elongated pedal bars pivotally or slidably coupled to the cycle frame and pivotally coupled to the main drive shaft with the cranks.

However, the pedal bars or the foot pedals may only be stepped up and down by the user, and the user may not effectively exercise his muscle groups. In addition, the stepping operation to the foot pedals may not be continuously operated such that the wheels may not be rotated in a great speed, and the muscle groups of the rider may easily fatigue.

The present invention has arisen to mitigate and/or obviate the afore-described disadvantages of the conventional cycle propelling mechanisms.

### SUMMARY OF THE INVENTION

The primary objective of the present invention is to provide a cycle propelling mechanism including a simplified structure for allowing the cycles to be easily and effectively operated or driven or propelled by the user and for effectively exercising the more or bigger muscle groups of the user, and for applying bigger power to the cycle propelling mechanism.

In accordance with one aspect of the invention, there is provided a cycle propelling mechanism comprising a cycle frame including a rail provided on the cycle frame, and including a main drive shaft, two cranks rotatably coupled to the main drive shaft of the cycle frame for allowing the cranks to be rotated and driven cyclically relative to the cycle frame, two levers each including a first end pivotally coupled to a free end of the crank, and a second end slidably coupled to the rail for allowing the levers to be moved cyclically relative to the cycle frame, and two foot pedals pivotally attached to the levers respectively for being stepped by user's feet and for allowing the cranks and the lever to be rotated relative to the cycle frame in an elliptical moving stroke and for allowing the foot pedals to be stepped and moved for a longer stepping or moving stroke by the user, and for effectively exercising the more or bigger muscle groups of the user.

The second ends of the levers are slidably coupled to the rail with a coupling device, for example, the coupling device may be slidably attached onto the rail and includes at least one roller attached to the coupling device for engaging with the rail and for allowing the second ends of the levers to be smoothly moved along the rail.

The foot pedals are pivotally and adjustably attached to the levers respectively. The levers each include at least one aperture formed therein for adjustably attaching and mounting the foot pedals and for adjusting the foot pedals relative to the cranks and the rail, and for adjusting the moving stroke of the foot pedals relative to the cycle frame.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of a cycle propelling mechanism in accordance with the present invention;

FIG. 2 is a partial exploded view of the cycle propelling mechanism;

FIG. 3 is another side plan schematic view similar to FIG. 1 illustrating the operation of the cycle propelling mechanism;

FIG. 4 is an enlarged partial side plan schematic view illustrating the operation of the cycle propelling mechanism;

FIG. 5 is a further side plan schematic view similar to FIGS. 1 and 3 illustrating the other arrangement of the cycle propelling mechanism; and

FIG. 6 is an enlarged partial side plan schematic view illustrating the operation of the cycle propelling mechanism as shown in FIG. 5.

### DETAILED DESCRIPTION OF THE PREFERRED EMBODIMENT

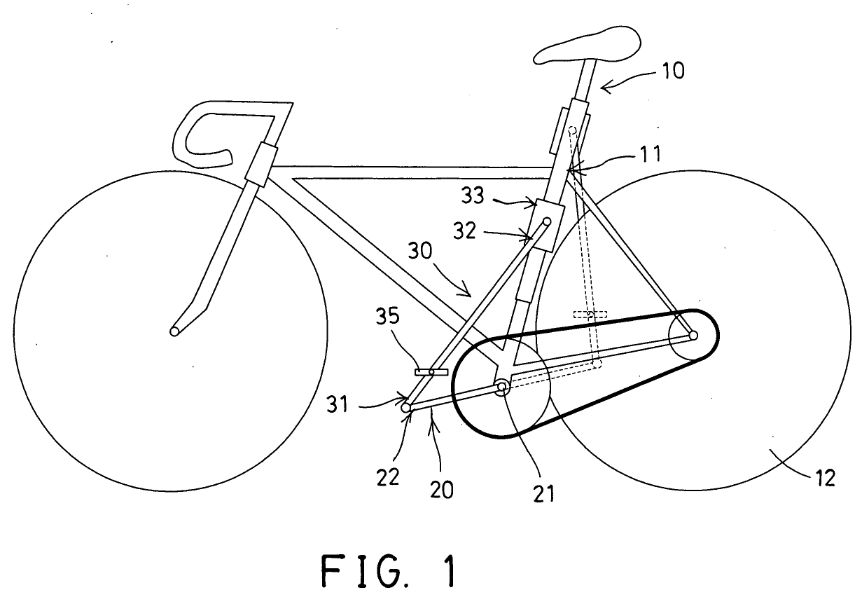

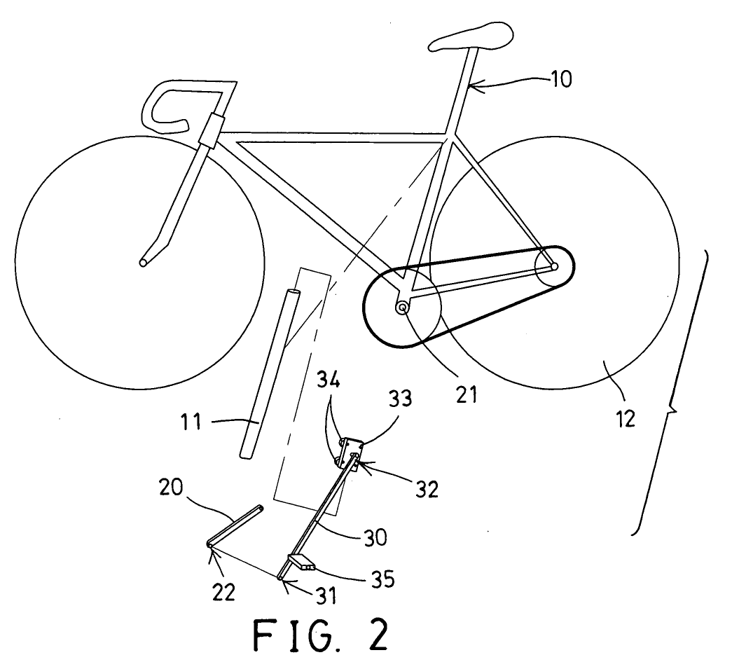

Referring to the drawings, and initially to FIGS. 1 and 2, a cycle propelling mechanism in accordance with the present invention comprises a cycle frame 10 including a track or rail 11 attached or mounted or provided or secured onto the cycle frame 10 and arranged up and down relative to the cycle frame 10 and disposed or arranged slightly inclined relative to the cycle frame 10, one or more (such as two) wheels 12 are attached or mounted or secured onto the cycle frame 10 for forming a unicycle, a bicycle, a tricycle or the like, and one or more (such as two) cranks 20 are pivotally or rotatably coupled to the cycle frame 10 with a main drive shaft 21 or coupled to the main drive shaft 21 of the cycle frame 10 for allowing the cranks 20 to be rotated or driven cyclically relative to the cycle frame 10.

One or more (such as two) links or levers 30 each include one end or lower end 31 pivotally or rotatably coupled to the respective free end 22 of the crank 20, and another end or upper end 32 pivotally and slidably coupled to the rail 11 with a coupling device 33 which is slidably attached or mounted onto the rail 11 and which includes one or more wheels or rollers 34 for engaging with the rail 11 and for allowing the other ends or upper ends 32 of the levers 30 to be smoothly slid or moved along the rail 11 and for allowing the levers 30 to be rotated or moved cyclically relative to the cycle frame 10. The coupling devices 33 are pivotally or rotatably coupled to the other ends or upper ends 32 of the levers 30 for allowing the other ends or upper ends 32 of the levers 30 to be pivoted or rotated relative to the coupling device 33 and the cycle frame 10.

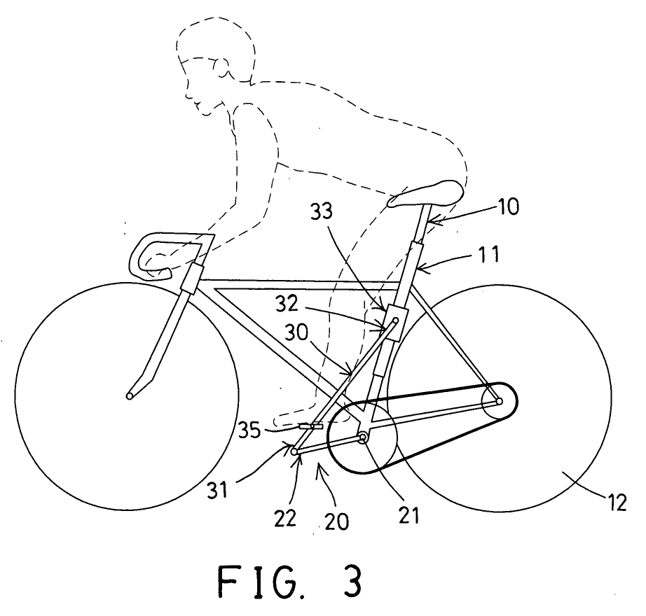

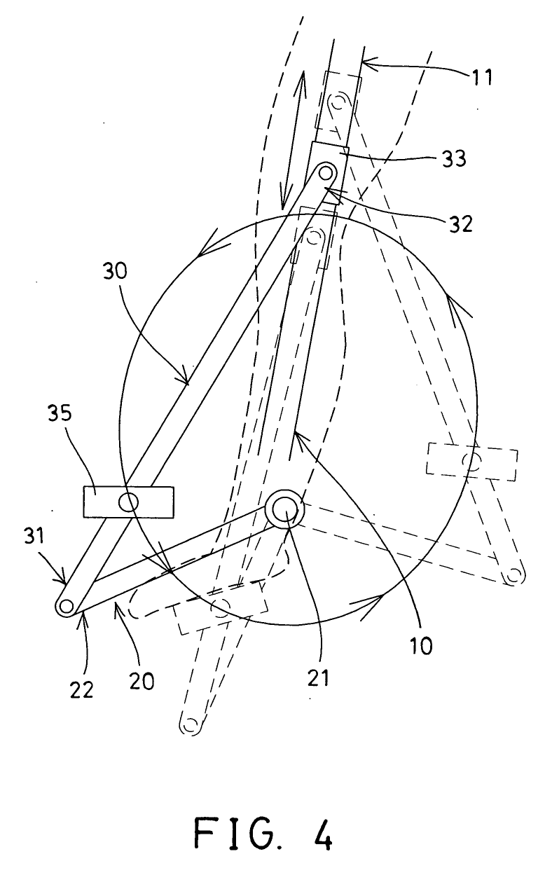

A foot support or foot pedal 35 is pivotally or rotatably attached or mounted or coupled to the middle or lower portion of each of the levers 30 for being engaged with and stepped by the feet of the user, and for allowing the cranks 20 and the lever 30 to be stepped and rotated or driven or propelled cyclically by the user. In operation, as shown in FIGS. 3 and 4, due to the pivotal coupling of the foot pedals 35 to the levers 30 and the coupling of the levers 30 between the cranks 20 and the rail 11, the foot pedals 35 may be stepped and caused to rotate relative to the cycle frame 10 in an elliptical moving stroke, best shown in FIG. 4, and the foot pedals 35 may be stepped and moved for a longer stepping or moving stroke by the user, and for effectively exercising the more or bigger muscle groups of the user.

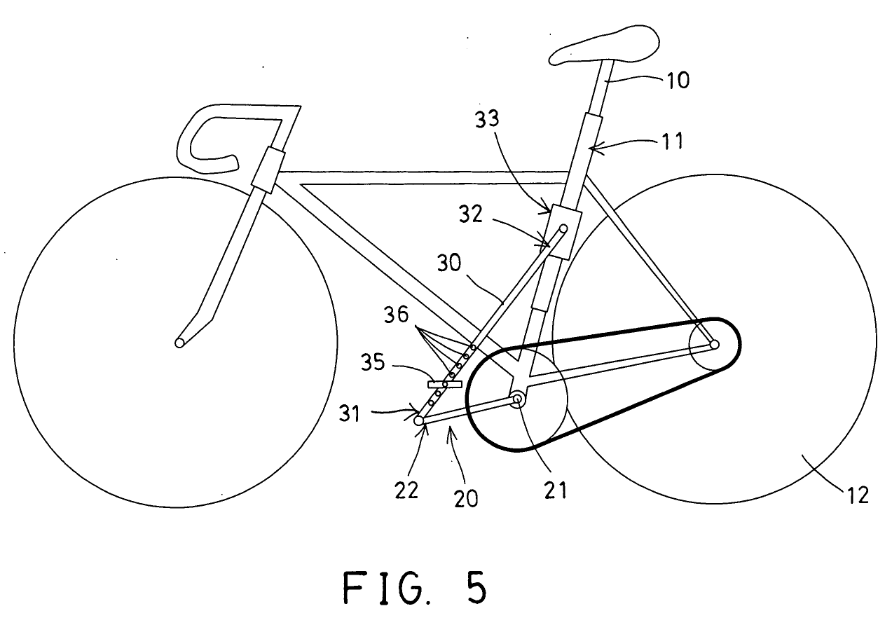

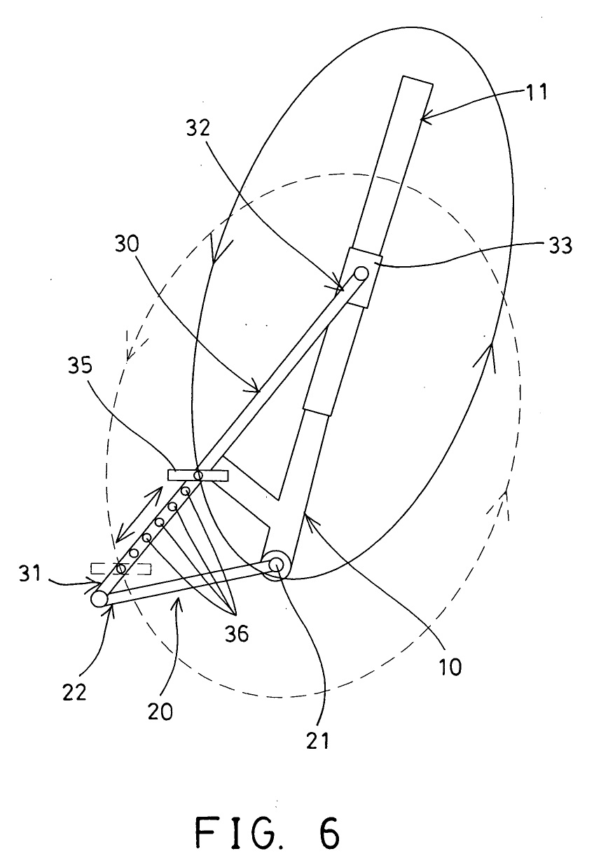

As shown in FIGS. 5 and 6, the levers 30 each include one or more apertures 36 formed therein for adjustably attaching or mounting or engaging with the foot pedals 35, and for adjusting the foot pedals 35 relative to the cranks 20 and the rail 11, and for adjusting the stepping or moving stroke of the foot pedals 35, and thus for adjusting the stepping force of the user applied to the foot pedals 35, and thus for adjusting the exercising operation to the more or bigger muscle groups of the user. It is to be noted that the lever 30 and the foot pedals 35 may be easily coupled between the cranks 20 and the rail 11 of the cycle frame 10 to have the foot pedals 35 stepped and moved for an elliptical moving stroke.

It is further to be noted that the foot pedals 35 may be stepped and moved in an elliptical moving stroke and may be stepped and rotated in a great speed, the effective moving stroke of the foot pedals 35 may be suitably increased and the effective acting component may be increased such that much more muscle groups of the user may be operated or exercised. The cycle propelling mechanism in accordance with the present invention is suitable for being stepped and operated by the user with a sitting status on the cycle saddle. The longitudinal axis of the elliptical moving stroke is equal to two times the length of the cranks 20, such that the length of the cranks 20 is greater than the length of the cranks for the typical cycle propelling mechanisms.

Accordingly, the cycle propelling mechanism in accordance with the present invention includes a simplified structure for allowing the cycles to be easily and effectively operated or driven or propelled by the user and for effectively exercising the more or bigger muscle groups of the user, and for applying bigger power to the cycle propelling mechanism.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cycle propelling mechanism comprising:
a cycle frame including a rail provided on the cycle frame, and including a main drive shaft,
two cranks rotatably coupled to said main drive shaft of said cycle frame for allowing said cranks to be rotated and driven cyclically relative to said cycle frame,
two levers each including a first end pivotally coupled to a free end of said crank, and a second end slidably coupled to said rail for allowing said levers to be moved cyclically relative to said cycle frame, and
two foot pedals pivotally attached to said levers respectively for being stepped by user's feet and for allowing said cranks and said lever to be rotated relative to said cycle frame in an elliptical moving stroke.

2. The cycle propelling mechanism as claimed in claim 1, wherein said second ends of said levers are each slidably coupled to said rail with a coupling device.

3. The cycle propelling mechanism as claimed in claim 2, wherein said coupling device is slidably attached onto said rail and includes at least one roller for engaging with said rail and for allowing said second ends of said levers to be smoothly moved along said rail.

4. The cycle propelling mechanism as claimed in claim 1, wherein said foot pedals are pivotally and adjustably attached to said levers respectively.

5. The cycle propelling mechanism as claimed in claim 4, wherein said levers each include at least one aperture formed therein for adjustably attaching and mounting said foot pedals and for adjusting said foot pedals relative to said cranks and said rail, and for adjusting the moving stroke of said foot pedals relative to said cycle frame.
